(19) United States
(12) Patent Application Publication
(10) Pub. No.: US 2008/0080107 A1
(43) Pub. Date: Apr. 3, 2008

(54) ESD protection for integrated circuits with multiple power domains

(75) Inventors: James Chow, Palo Alto, CA (US); Hua Chen, Nanjing (CN)

Correspondence Address: Silicon Valley Patent Group LLP, 18805 Cox Avenue, Suite 220, Saratoga, CA, 95070, US

(73) Assignee: Huaya Microelectronics, Ltd., San Jose, CA (US)

(21) Appl. No.: 11/529,892

(22) Filed: Sep. 29, 2006

(51) Int. Cl. H02H 9/00

(52) U.S. Cl. 361/56

(57) ABSTRACT

An integrated circuit with ESD protection for multiple power domains is disclosed. A first ESD protection circuit is coupled in between the power pad of the first power domain and the ground pad of the second power domain to dissipate energy from electrostatic discharges. Similarly, a second ESD protection circuit is coupled in between the power pad of the second power domain and the ground pad of the first power domain.

### BACKGROUND OF THE INVENTION

1. Field of the Invention

The present invention relates to mixed signal integrated circuits. More specifically, the present invention relates methods and circuits to protect mixed signal integrated circuits from electrostatic discharge (ESD).

2. Discussion of Related Art

Electrostatic discharge (ESD) is a sudden and momentary electric current caused by an imbalance of electric charge. While ESD is a minor annoyance in everyday life, ESD can cause significant damage to integrated circuits. Furthermore, as device sizes shrink the vulnerability of integrated circuits to ESD damage is increased. In particular, MOSFETs, which now dominate the integrated circuit industry, are particularly vulnerable due to the thin gate oxide used in MOSFETs.

In general integrated circuits are packaged into “chips”. Bonding pads on the integrated circuits are connected to pins on the chips. Damage to the integrated circuit is possible when electrostatic discharge surges into pins of the chip, which are connected to bonding pads. The bonding pads are coupled to the various circuits in the IC which can be damaged by the electrostatic discharge.

To prevent ESD from damaging the IC, ESD protection circuits are inserted between bonding pads to allow the current from the electrostatic discharge to be dissipated. For example, conventional chips insert ESD protection circuits between input/output pads and power pads, between input/output pads and ground pads, and between power pads and ground pads.

FIG. 1 is a simplified block diagram of an integrated circuit 100 with ESD protection. For clarity, only one power pad, one ground pad, and one input/output pad of integrated circuit 100 is shown. Actual integrated circuits may include multiple power pads and ground pads for better power distribution and would include many more input/output pads. In FIG. 1, integrated circuit 100 includes a power pad 110, a ground pad 120, logic circuit 130, input/output pad 140, and ESD protection circuits 150, 160, and 170. Logic circuit 130 is coupled to power pad 110, ground pad 120, and input/output pad 140. Specifically, power pad 110 and ground pad 120 provides the power to operate logic circuit 130 and input/output pad 140 provides the input signal or output signal of logic circuit 130. Logic Circuit 130 may include buffering circuits such as resistors that are used in coupling to input/output pad 140. An actual integrated circuit would include multiple logic circuits and have multiple input/output pads. Furthermore, some logic circuits may be coupled to multiple input/output pads and other logic circuits only provide internal logic and would not directly coupled to any input/output pads. ESD protection circuit 150 is coupled between power pad 110 and ground pad 120. ESD protection circuit 160 is coupled between input/output pad 140 and power pad 110. ESD protection circuit 170 is coupled between input/output pad 140 and ground pad 120.

Generally, ESD protection circuits are designed to allow electrostatic discharges to be dissipated without damaging logic circuit 130. Under normal voltage conditions, the ESD protection circuits have very high impedance and do not electrically effect the other circuits. However, under high voltage conditions, such as during an electrostatic discharge, the ESD protection circuits become conducting so that the energy from the electrostatic discharge is routed away from the logic circuits. Thus, for example an electrostatic discharge between power pad 110 and ground pad 120 would be dissipated through ESD protection circuit 150. Similarly, an electrostatic discharge between input/output pad 140 and power pad 110 is dissipated through ESD protection circuit 160 and an electrostatic discharge between input/output pad 140 and ground pad 120 is dissipated through ESD protection circuit 170. ESD protection circuits are well known in the art and the specific ESD protection circuit circuits are not an integral part of the present invention. The present invention can be used with a variety of ESD protection circuits. Typical ESD protection circuits include but are not limited to diodes, Zener diodes, NPN transistors, PNP transistors, PMOS transistors, NMOS transistors, Silicon controlled rectifiers (SCR), RC circuits, transistors combined with resistors, etc.

As semiconductor processing has improved, integrated circuits have begun to use multiple power sources and thus multiple power domains. For example, some chips may include circuits in a first power domain that run at a first voltage level while other circuits in a second power domain operate at a second voltage level. Mixed signal integrated circuits, include both digital and analog circuits. Generally, the analog circuits and digital circuits are parts of different power domains. Each power domain would have a different set of power bonding pads and ground bonding pads.

FIG. 2 is a simplified block diagram of an integrated circuit 200 that has two power domains. For clarity, only one power pad, one ground pad, and one input/output pad for each power source are shown. In FIG. 2, integrated circuit 200 includes a first power pad 210A, a first power domain ground pad 220A, first power domain logic circuit 230A, a first power domain input/output pad 240A, ESD protection circuits 250A, 260A, and 270A, a second power domain power pad 210B, a second power domain ground pad 220B, a second power domain logic circuit 230B, a second power domain input/output pad 240B, and ESD protection circuits 250B, 260B, and 270B. Circuits, pads, and ESD protection circuits in the first power domain are labeled with an “A”, such as power pad 210A, which is a first power domain power pad; conversely, circuits, pads, and ESD protection circuits in the second power domain are labeled with a “B”, such as power pad 210B, which is a second power domain power pad. For brevity the “first power domain” and “second power domain” adjectives are omitted in favor of using the reference numerals having “A” or “B”. Power in the first power domain would be provided through power pad 210A and the associated ground pad 220A. Power in the second power domain would be provided through power pad 210B and the associated ground pad 220B.

Logic circuit 230A is coupled to power pad 210A, ground pad 220A, and input/output pad 240A. ESD protection circuit 250A is coupled between power pad 210A and ground pad 220A. ESD protection circuit 260A is coupled between input/output pad 240A and power pad 210A. ESD protection circuit 270A is coupled between input/output pad 240A and ground pad 220A. Logic circuit 230B is coupled to power pad 210B, ground pad 220B, and input/output pad 240B. ESD protection circuit 250B is coupled between power pad 210B and ground pad 220B. ESD protection circuit 260B is coupled between input/output pad 240B and power pad 210B. ESD protection circuit 270B is coupled between input/output pad 240A and ground pad 220B. ESD protection circuits 250A, 260A, and 270A in FIG. 2 perform the same functions as ESD protection circuits 150, 160, and 170 in FIG. 1 as described above to dissipate electrostatic discharge among power pad 210A, input/output pad 240A, and ground pad 220A. Similarly, ESD protection circuits 250B, 260B, and 270B in FIG. 2 perform the same functions as ESD protection circuits 150, 160, and 170 in FIG. 1 as described above to dissipate electrostatic discharge among power pad 210B, input/output pad 240B, and ground pad 220B. However, electrostatic discharge that occurs between the power domains, i.e. between one of the “A pads” (i.e. power pad 210A, input/output pad 240A, or ground pad 220A) and one of the “B pads” (i.e. power pad 210B, input/output pad 240B, or ground pad 220B), may still cause damage to logic circuits 230A and logic circuit 230B.

FIG. 3 is a simplified block diagram of an integrated circuit 300, that includes ESD protection circuits to minimize damage caused by electrostatic discharge between the “A pads” and the “B pads”. FIG. 3 is very similar to FIG. 2 and similar components are labeled with the same reference numerals. Therefore the description of these components is not repeated. FIG. 3 adds ESD protection circuits 310 and 320 to the circuits of FIG. 2. ESD protection circuit 310 is coupled between power pad 210A and power pad 210B. ESD protection circuit 320 is coupled between ground pad 220A and ground pad 220B. In FIG. 3, ESD protection circuit 310 and ESD protection circuit 320 are a pair of diodes. Specifically, ESD protection circuit 310 includes a first diode 314, having an input terminal coupled to power pad 210A and an output terminal coupled to power pad 210B, and a second diode 318 having an input terminal coupled to power pad 210B and an output terminal coupled to power pad 210A. Similarly, ESD protection circuit 320 includes a first diode 324, having an input terminal coupled to ground pad 220A and an output terminal coupled to ground pad 220B, and a second diode 328 having an input terminal coupled to ground pad 220B and an output terminal coupled to ground pad 210B. If an electrostatic discharge occurs between the power domains, ESD protection circuit 310 or ESD protection circuit 320 provides a discharge path to dissipate the electrostatic discharge. For example if an electrostatic discharge occurs between input/output pad 240A and input/output pad 240B, the electrostatic discharge can be dissipated through ESD protection circuit 260A, ESD protection circuit 310, and ESD protection circuit 260B or through ESD protection circuit 270A, ESD protection circuit 320, and ESD protection circuit 270B.

However, ESD protection circuit 310 has several limitations. First, ESD protection circuit 310 can only be used if the voltage level on power pad 210A and 210B are within the threshold voltage and breakdown voltage of diodes 314 and 318. For example, if power pad 210A is at a voltage V_A, and power pad 210B is at a voltage V_B, where voltage V_A is greater than voltage V_B by more than the threshold voltage V_T of diode 314, current would flow from power pad 210A to power pad 210B. Thus, the power domains would no longer be isolated and noise from one power domain may interfere with the operation of the other power domain. In addition, the voltage levels in the power domain would also be changed. Furthermore, diodes have high series resistance and thus are less effective for dissipating the electrostatic discharge. In addition, ESD protection circuit 310 may also cause problems during power up because the voltage on power pad 210A and power pad 210B may reach the desired voltage at different times. Hence, there is a need for a method or circuit that can provide protection for electrostatic discharge between power domains of different voltages or different signal types on an integrated circuits.

### SUMMARY

Accordingly, the present invention provides an integrated circuit with multiple power domains that is protected against electrostatic discharge. An integrated circuit with multiple power domains includes a first-power-domain power pad for the first power domain, a first-power-domain ground pad for the first power domain, a first-power-domain logic circuit coupled between the first-power-domain power pad and the first-power-domain ground pad; a second-power-domain power pad for the second power domain; a second-power-domain ground pad for the second power domain; and a second-power-domain-logic circuit coupled between the second-power-domain power pad and the second-power-domain ground pad. In accordance with one embodiment of the present invention a first ESD protection circuit is coupled between the first-power-domain power pad and the second-power-domain ground pad. When an electrostatic discharge occurs between the first-power-domain power pad and the second-power-domain ground pad, the first ESD protection circuit becomes conducting to dissipate the power of the electrostatic discharge without harming the logic circuits. Some embodiments of the present invention also include a second ESD protection circuit coupled between the second-power-domain power pad and the first-power-domain ground pad.

The present invention will be more fully understood in view of the following description and drawings.

### BRIEF DESCRIPTION OF THE DRAWINGS

FIG. 1 is a simplified block diagram of a conventional integrated circuit.

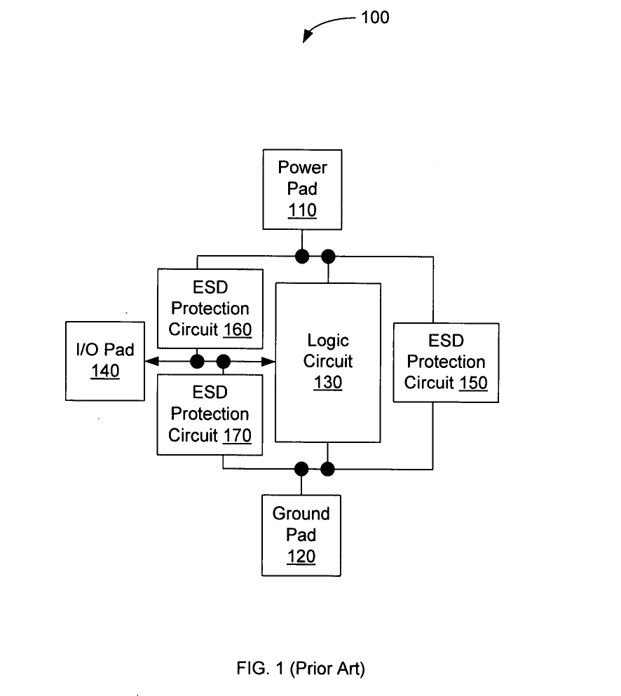

FIG. 2 is a simplified block diagram of a conventional integrated circuit with multiple power domains.

FIG. 3 is a simplified block diagram of a conventional integrated circuit with multiple power domains and discharge paths between the power domains.

FIG. 4 is a simplified block diagram of an integrated circuit with multiple power domains and discharge paths between the power domains.

FIG. 5 is a simplified block diagram of an integrated circuit in accordance with one embodiment of the present invention.

FIGS. 6(a) and 6(b) show ESD protection circuits in accordance with one embodiment of the present invention.

### DETAILED DESCRIPTION

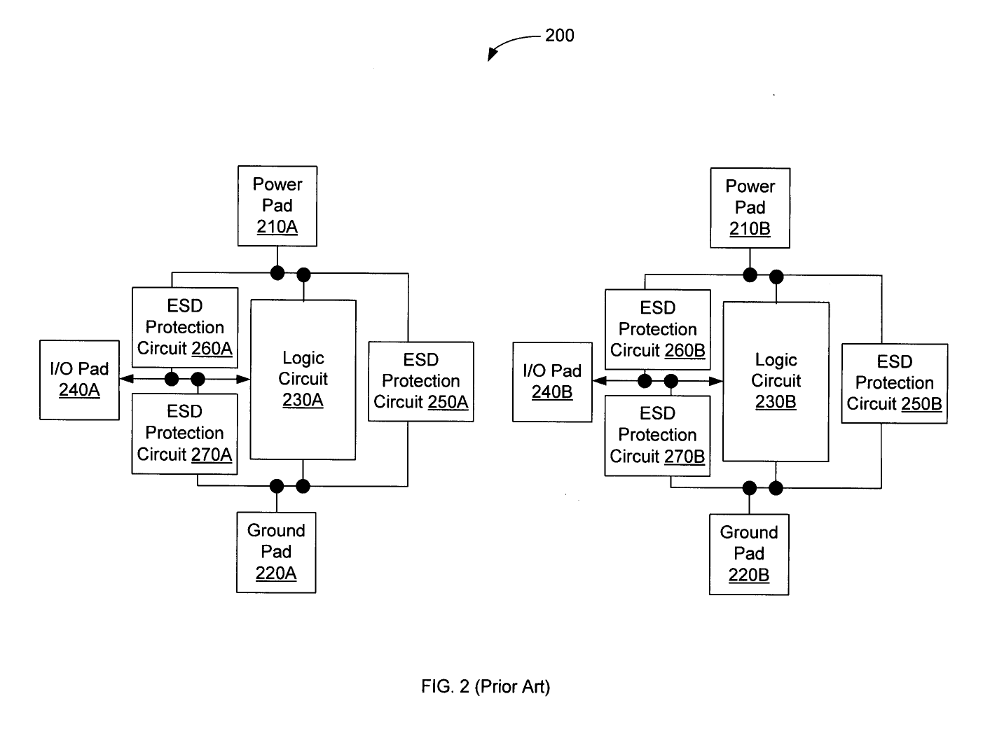

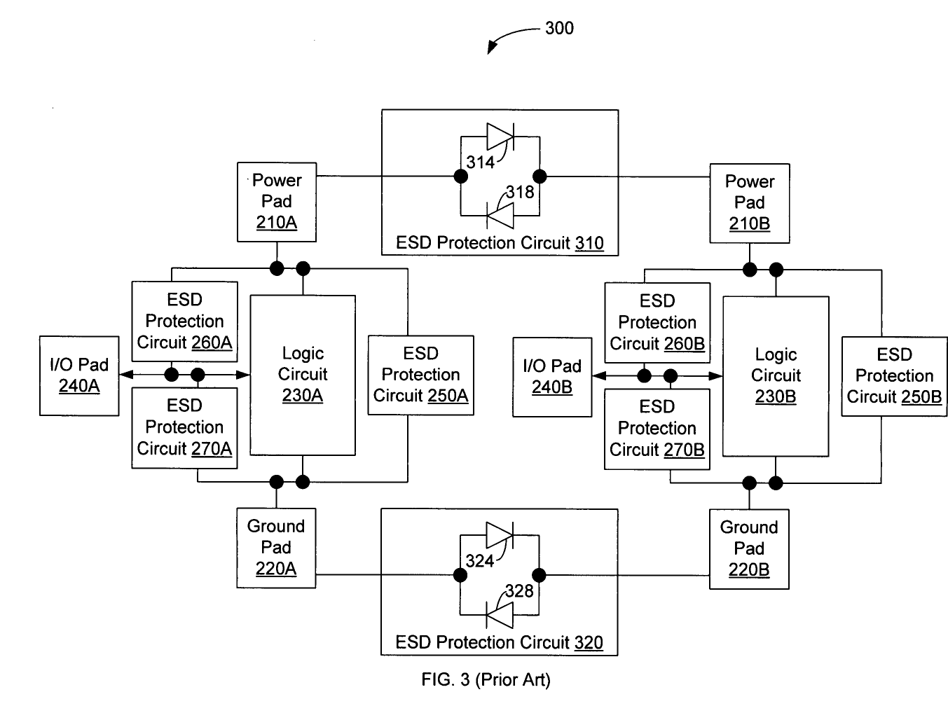

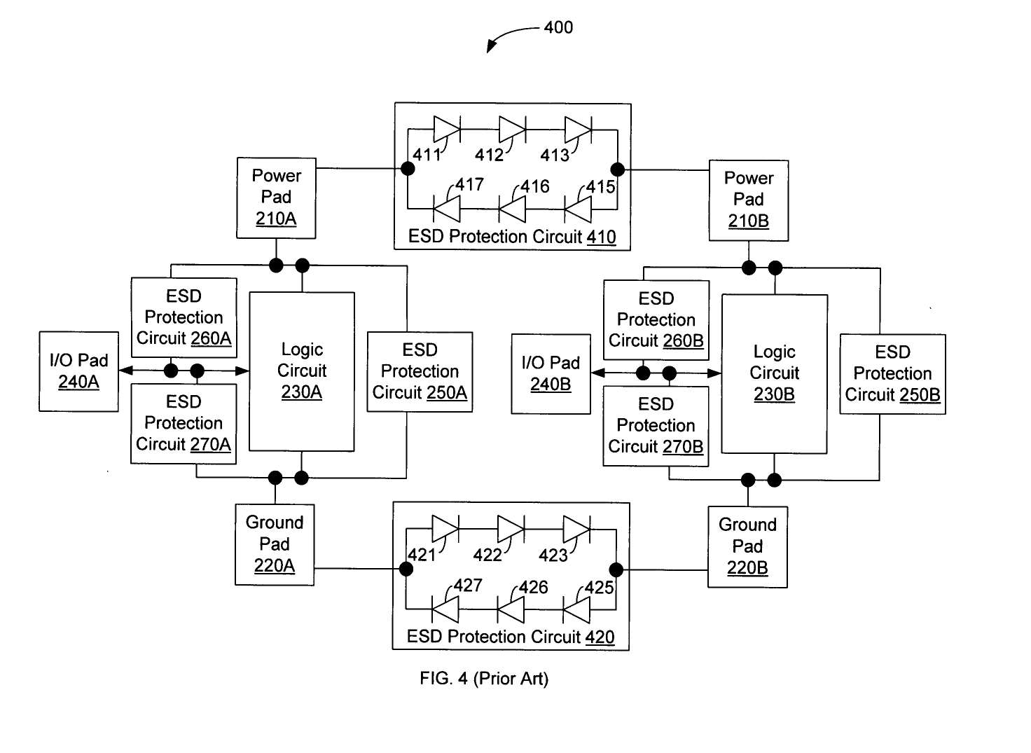

As explained above, conventional integrated circuit with multiple power domains with electrostatic discharge protection have several problems, such as constrained voltage levels in the power domains, noise coupling, and power up sequence issues. FIG. 4 is a simplified block diagram of an integrated circuit 400 that provides protection against electrostatic discharge while allowing power domains to have different voltage levels. FIG. 4 is very similar to FIG. 3 (and FIG. 2) and similar components are labeled with the same reference numerals. Therefore the description of these components is not repeated. FIG. 4 replaces ESD protection circuits 310 and 320 with ESD protection circuits 410 and 420 respectively. ESD protection circuits 410 and 420 replaces each diode of ESD protection circuits 310 and 320 with multiple diodes in series. Specifically, ESD protection circuit 410 includes diodes 411, 412, and 413 coupled in series with the input terminal of diode 411 coupled to power pad 210A and the output terminal of diode 413 coupled to power pad 210B. ESD protection circuit 410 also includes diodes 415, 416, and 417 coupled in series with the input terminal of diode 415 coupled to power pad 210B and the output terminal of diode 417 coupled to power pad 210A. ESD protection circuit 420 includes diodes 421, 422, and 423 coupled in series with the input terminal of diode 421 coupled to ground pad 220A and the output terminal of diode 423 coupled to ground pad 220B. ESD protection circuit 420 also includes diodes 425, 426, and 427 coupled in series with the input terminal of diode 425 coupled to ground pad 220B and the output terminal of diode 427 coupled to ground pad 220A. The diodes coupled in series in FIG. 4 provide the same basic functionality as the single diode in FIG. 3. However, due by putting several diodes in series, the voltage level on of the power domain can be different by as much as the sum of the threshold voltages of the diodes in series. Thus, for example with three diodes are coupled in series between power pad 210A and power pad 210B, the voltage level on power pad 210A and power pad 210B can be different by as much as three times the threshold voltage of a single diode. Thus, using a series of diodes in ESD protection circuit 410 allows power domains to have different voltages. However, the other problems such as the high series resistance of the diodes, which reduces the effectiveness of the ESD protection, are actually worsened.

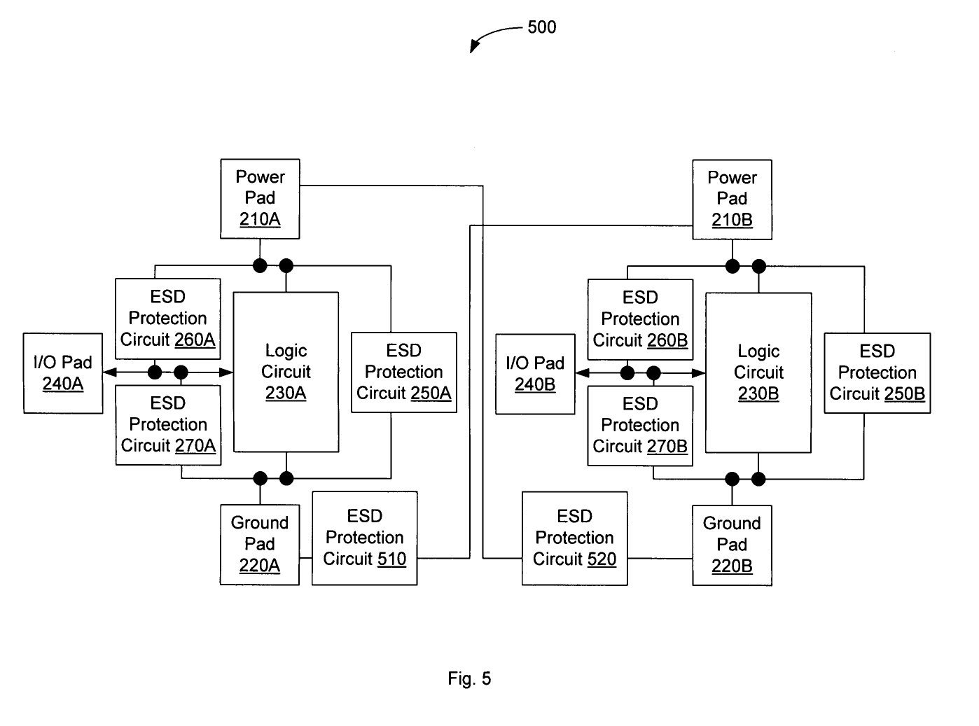

FIG. 5 is a simplified block diagram of an integrated circuit 500 in accordance with one embodiment of the present invention. FIG. 3 is very similar to FIG. 2 and similar components are labeled with the same reference numerals. Therefore the description of these components is not repeated. FIG. 5 adds ESD protection circuits 510 and 520 to the circuits of FIG. 2. Specifically, an ESD protection circuit 510 is coupled between Ground pad 220A and power pad 210B, while ESD protection circuit 520 is coupled between ground pad 220B and Power pad 210A. As explained above ESD protection circuits are designed to have very high impedance at normal operating voltages. Thus, during normal operating voltages ESD protection circuit 510 and ESD protection circuit 520 would be non-conducting. However during an electrostatic discharge that creates a large voltage imbalance between power pad 210B and ground pad 220A, ESD protection circuit 510 protects logic circuits 230A and 230B by becoming conducting and dissipates the energy from the electrostatic discharge. Similarly, during an electrostatic discharge that creates a large voltage imbalance between power pad 210A and ground pad 220B, ESD protection circuit 520 protects logic circuits 230A and 230B by becoming conducting and dissipates the energy from the electrostatic discharge.

For example, in one embodiment of the present invention, ESD protection circuit 510 is a diode that is reverse biased between power pad 210B and ground pad 220A. The reverse breakdown voltage of the diode is set to be greater than the typical operating voltage applied to power pad 210B. Therefore, during normal operation the reverse biased diode prevents current from flowing from power pad 210B to ground pad 220A. However, if a positive electrostatic discharge occurs between power pad 210B and Ground pad 220A (i.e. the voltage on power pad 210B is driven significantly higher than the voltage at ground pad 220A), the diode would conduct if the electrostatic discharge voltage is greater than the reverse breakdown voltage of the diode. Thus, the power of the electrostatic discharge can be dissipated through the diode. Furthermore, if a negative electrostatic discharge occurs between power pad 210B and ground pad 220A (i.e. the voltage on ground pad 220A is driven higher than the voltage at power pad 210B) the diode becomes forward biased and would become conducting, which allows the power of the electrostatic discharge to be dissipated. ESD protection circuit 520 would work similarly between power pad 210A and ground pad 220B.

The presence of ESD protection circuit 510 and ESD protection circuit 520 provides protection against electrostatic discharges between any bonding pad across the power domains. For example, if an electrostatic discharge occurs between ground pad 220B and input/output pad 240A, the power from the electrostatic discharge is dissipated through ESD protection circuit 260A and ESD protection circuit 520. Some of the power may also be dissipated through ESD protection circuits 270A, ESD protection circuit 250A, and ESD protection circuit 520 or through ESD protection circuit 270A, ESD protection circuit 510, and ESD protection circuit 250B.

Because, the present invention provides ESD protection circuits between power pads and ground pads rather than between power pads of different power domains, the voltages of the different power domains are not tied together and can thus use different voltage levels. Furthermore, noise fluctuation from one power domain is not injected into the other power domain.

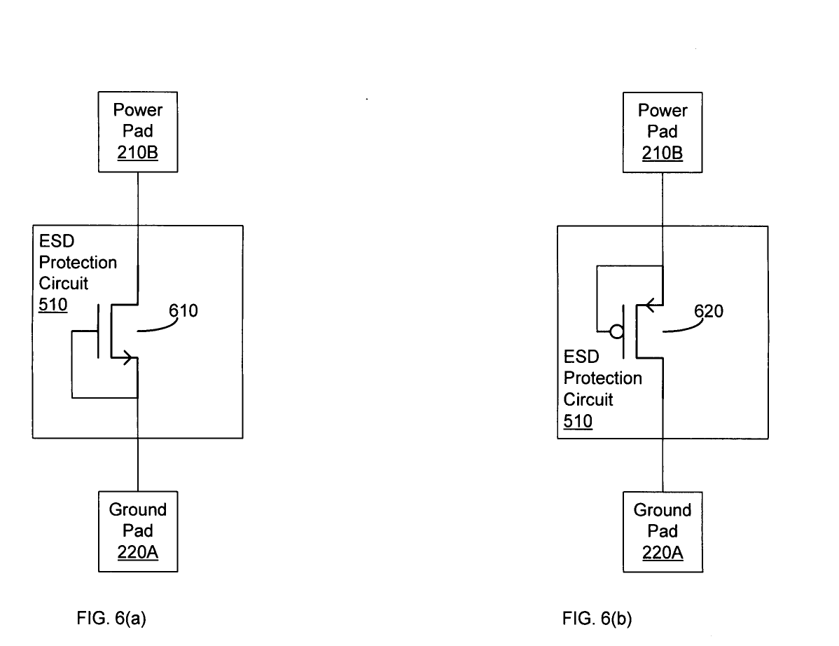

FIG. 6(a) is one embodiment for ESD protection circuit 510 in accordance with the present invention. The embodiment of FIG. 6(a) is a NMOS transistor 610 having a first power terminal coupled to power pad 210B, a second power terminal coupled to ground pad 220A and a control terminal coupled to ground pad 220A. During normal operation, NMOS transistor 610 is non-conducting due to having its control terminal coupled to ground pad 220A. However, if an electrostatic discharge raises the voltage of ground pad 220A to be greater than the voltage of power pad 210B plus the threshold voltage of NMOS transistor 610, NMOS transistor 610 becomes conducting and can dissipate the energy from the electrostatic discharge. In addition, if an electrostatic discharge raises the voltage of power pad 210B to be greater than the breakdown voltage of NMOS transistor 610, NMOS transistor 610 becomes conducting and can dissipate the energy from the electrostatic discharge.

FIG. 6(b) is a second embodiment for ESD protection circuit 510 in accordance with the present invention. The embodiment of FIG. 6(b) is a PMOS transistor 620 having a first power terminal coupled to power pad 210B, a second power terminal coupled to ground pad 220A and a control terminal coupled to power pad 210B. During normal operation, PMOS transistor 610 is non-conducting due to having its control terminal coupled to power pad 210B. However, if an electrostatic discharge raises the voltage of ground pad 220A to be greater than the voltage of power pad 210B plus the threshold voltage of PMOS transistor 620, PMOS transistor 610 becomes conducting and can dissipate the energy from the electrostatic discharge. In addition, if an electrostatic discharge raises the voltage of power pad 210B to be greater than the breakdown voltage of PMOS transistor 620, PMOS transistor 620 becomes conducting and can dissipate the energy from the electrostatic discharge.

The embodiments of ESD protection circuit 510 in FIGS. 6(a) and 6(b) can also be used for ESD protection circuit 520. However as explained above, the present invention is applicable for almost any ESD protection circuits and the specific type of ESD protection circuit used in an integrated circuit is not an integral part of the present invention.

In a particular embodiment of the present invention, a mixed signal integrated circuit has an analog power domain operating at 3.3 Volts and a digital power domain operating at 1.8 volts. In this integrated circuit, ESD protection circuit 510, i.e. the ESD protection circuit between the power pad of the analog power domain and the ground of the digital power domain is an NMOS transistor having a width of 360 micrometers, a length of 0.18 micrometers, threshold voltage of approximately 0.5 V and breakdown voltage of about 10 V. ESD protection circuit 520, i.e. the ESD protection circuit between the power pad of the digital power domain and the ground of the analog power domain is a similar NMOS transistor.

In the various embodiments of the present invention, novel circuits and methods have been described for creating an integrated circuit with protection against electrostatic discharge. The various embodiments of the structures and methods of this invention that are described above are illustrative only of the principles of this invention and are not intended to limit the scope of the invention to the particular embodiments described. For example, in view of this disclosure those skilled in the art can define other power domains, power pads, ground pads, ESD protection circuits, transistors, and so forth, and use these alternative features to create a method, or system according to the principles of this invention. Thus, the invention is limited only by the following claims.

What is claimed is

1. An integrated circuit having a first power domain and a second power domain, the integrated circuit comprising:
a first-power-domain power pad for the first power domain;
a first-power-domain ground pad for the first power domain;
a fist-power-domain logic circuit coupled between the first-power-domain power pad and the first-power-domain ground pad;
a second-power-domain power pad for the second power domain;
a second-power-domain ground pad for the second power domain;
a second-power-domain-logic circuit coupled between the second-power-domain power pad and the second-power-domain ground pad; and
a first ESD protection circuit coupled between the first-power-domain power pad and the second-power-domain ground pad.

2. The integrated circuit of claim 1, further comprising a second ESD protection circuit coupled between the second-power-domain power pad and the first-power-domain ground pad.

3. The integrated circuit of claim 2, wherein the second ESD protection circuit comprises a NMOS transistor.

4. The integrated circuit of claim 3, wherein the NMOS transistor comprises:
a first power terminal coupled to the second-power-domain power pad;
a second power terminal coupled to the first-power-domain ground pad; and
a control terminal coupled to the first-power-domain ground pad.

5. The integrated circuit of claim 2, wherein the second ESD protection circuit comprises a PMOS transistor.

6. The integrated circuit of claim 5, wherein the PMOS transistor comprises:
a first power terminal coupled to the second-power-domain power pad;
a second power terminal coupled to the first-power-domain ground pad; and
a control terminal coupled to the second-power-domain power pad.

7. The integrated circuit of claim 2, wherein the second ESD protection circuit is a diode.

8. The integrated circuit of claim 1, wherein the first ESD protection circuit comprises a NMOS transistor.

9. The integrated circuit of claim 8, wherein the NMOS transistor comprises:
a first power terminal coupled to the first-power-domain power pad;
a second power terminal coupled to the second-power-domain ground pad; and
a control terminal coupled to the second-power-domain ground pad.

10. The integrated circuit of claim 1, wherein the first ESD protection circuit comprises a PMOS transistor.

11. The integrated circuit of claim 10, wherein the PMOS transistor comprises:
a first power terminal coupled to the first-power-domain power pad;
a second power terminal coupled to the second-power-domain ground pad; and
a control terminal coupled to the first-power-domain power pad.

12. The integrated circuit of claim 1, wherein the first ESD protection circuit comprises a diode.

13. The integrated circuit of claim 1, further comprising:
a first-power-domain input/output pad coupled to the first-power-domain logic circuit;
a second ESD protection circuit coupled between the first-power-domain input/output pad and the first-power-domain ground pad.

14. The integrated circuit of claim 12; further comprising
a third ESD protection circuit coupled between the first-power-domain input/output pad and the first-power-domain power pad; and
a fourth ESD protection circuit coupled between the first-power-domain power pad and the first-power-domain ground pad.

15. The integrated circuit of claim 1, wherein the first power domain is an analog domain and the second power domain is a digital domain.

16. The integrated circuit of claim 1, wherein the first power domain has a first voltage, the second power domain has a second voltage, and the first voltage is greater than the second voltage.

17. A method of protecting an integrated circuit having a first power domain and a second power domain from an electrostatic discharge, the method comprising:
conducting power of the electrostatic discharge from a second-power-domain power pad of the second power domain to a first-power-domain ground pad of the first power domain when the electrostatic discharge raises the voltage of the second-power-domain power pad; and
conducting power of the electrostatic discharge from the first-power-domain ground pad to the second-power-domain power pad when the electrostatic discharge raises the voltage of the first-power-domain ground pad.

18. The method of claim 17, further comprising:
conducting power of the electrostatic discharge from a first-power-domain power pad of the first power domain to a second-power-domain ground pad of the second power domain when the electrostatic discharge raises the voltage of the first-power-domain power pad; and
conducting power of the electrostatic discharge from the second-power-domain ground pad of the second power domain to the first-power-domain power pad when the electrostatic discharge raises the voltage of the second-power-domain ground pad.

19. An integrated circuit having a first power domain and a second power domain, the integrated circuit comprising:
means for conducting power of an electrostatic discharge from a second-power-domain power pad of the second power domain to a first-power-domain ground pad of the first power domain when the electrostatic discharge raises the voltage of the second-power-domain power pad; and
means for conducting power of the electrostatic discharge from the first-power-domain ground pad to the second-power-domain power pad when the electrostatic discharge raises the voltage of the first-power-domain ground pad.

20. The integrated circuit of claim 19, further comprising:
means for conducting power of the electrostatic discharge from a first-power-domain power pad of the first power domain to a second-power-domain ground pad of the second power domain when the electrostatic discharge raises the voltage of the first-power-domain power pad; and
means for conducting power of the electrostatic discharge from the second-power-domain ground pad of the second power domain to the first-power-domain power pad when the electrostatic discharge raises the voltage of the second-power-domain ground pad.
